(19) United States
(12) Patent Application Publication
(10) Pub. No.: US 2023/0321484 A1
(43) Pub. Date: Oct. 12, 2023

(54) Core Stimulator and Stabilizer System and Method

(71) Applicant: Core Set Fitness Corporation, Marina Del Rey, CA (US)

(72) Inventor: Jill Michele Melean, Marina Del Rey, CA (US)

(21) Appl. No.: 18/298,302

(22) Filed: Apr. 10, 2023

Related U.S. Application Data
(60) Provisional application No. 63/329,805, filed on Apr. 11, 2022.

(51) Int. Cl. A63B 23/02; A63B 21/065; A61H 39/04

(52) U.S. Cl. CPC A63B 23/02; A63B 21/065; A61H 39/04; A63B 2209/10; A63B 2208/0252; A61H 2205/083; A61H 2201/1685; A61H 2201/1695; A61H 2209/00; A61H 2201/1261

(57) ABSTRACT

Systems and methods for improved core work-out training are disclosed. In preferred embodiments, the CORE SET™ system discloses a flexible, comfortable belt having a pocket for securely receiving one or more weights and that tightly wraps around the abdomen of an exerciser. The weight is positioned over the abdomen, such that during on-the-back exercises, such as sit ups and crunches, the user's back is stabilized and positioned properly flat on the ground for isolated muscle work outs. An optional acupressure sheet to be applied to abdomen is also disclosed.

### REFERENCE TO RELATED APPLICATIONS

This application claims the priority benefit of U.S. Provisional Patent Application No. 63/329,805 filed on Apr. 11, 2022, hereby incorporated by reference in its entirety as though fully set forth herein.

### BACKGROUND OF THE INVENTION

The present invention pertains to the field of exercise devices, and in particular to waist wraps and belts designed to help improve the health fitness and strength of the core region of exercisers who wear these devices.

The core of the human body refers to the muscles, bones and tissues that stabilize and support the spine, pelvis, and trunk. The core muscles include the rectus abdominis, obliques, transverse abdominis, erector spinae, and multifidus (the group of small back muscles that run along the spine). Strengthening the core by exercising these muscles provides numerous benefits, including, but not limited to (a) improved posture: Strong core muscles help to keep the spine and pelvis in alignment, reducing strain on the back and improving posture; (b) increased stability and balance: A strong core helps to improve balance and stability, which can reduce the risk of falls and injuries, particularly important as people age; (c) reduced risk of back pain: Core exercises can help to strengthen the muscles that support the spine, reducing the risk of back pain and injury; (d) improved athletic performance: a strong core is essential for many athletic activities, including those that involve running, jumping, and throwing; and (e) improved overall fitness: core exercises can be incorporated into a well-rounded fitness routine, improving overall strength, endurance, and flexibility. In sum, a regular and sustained routine of core exercising can provide great health and longevity benefits to both men and women, especially as they age.

One category of conventional, “tried and true” exercises effective for maintaining and strengthening the core has the exerciser lying down with his/her back flat on the ground. These include among others sit-ups, crunches and “dead bugs,” each having a variety of ways of performing them. However, there better and less effective ways to perform these back-to-the-ground exercises. Some people tend to expand their rib cage and thereby lift their back off the floor or floor mat and raise the stomach up. This is incorrect and should be avoided. Instead, the proper way to do a back-to-the-ground core work-out is to keep the back flush to the ground (until, of course, in the case of a sit-up rep, the exercise lifts her entire torso off the ground). This is best accomplished by consciously tilting the pelvis up and dropping the chest. Keeping the back flat on the ground throughout the reps is important for effectively engaging the abdominal muscles and preventing injury. However, because it is often difficult or not natural for exercisers and patients in physical therapy to stabilize their torsos themselves to maintain this on-the-floor back position, trainers and therapists need to constantly remind them to stabilize. Some coaches even help stabilize the core of their exercisers by physically pressing down on the stomach to keep the back from arching up.

Abdominal belts, also known as waist trainers or waist cinchers, have been used as a tool to enhance torso exercises and to help shape the waist area. Waist belts are also used by bodybuilders to support the lower back and abdominal muscles during heavy lifting exercises. They are typically made of a compressive material, such as neoprene, and are designed to be worn tightly around the waist. The idea behind conventional waist wraps (other than for weightlifters) is that they can help increase the intensity of abdominal workouts by providing additional support to the core muscles during core workouts. Compressing the waist, these devices can also somewhat help to increase blood flow to the area, which can aid in the delivery of nutrients and oxygen to the muscles, potentially leading to increased strength and endurance.

However, conventional waist straps and belts come with numerous limitations that make them of limited utility for these purposes. While they do a good job of compressing the waist, they unfortunately do not address or correct the key technical mistakes of exercisers during their core workouts: they do not address the common problem of back arching discussed above. It would thus be desirable to have a device that is capable of isolating and stabilizing the core during “back to the ground” exercises to such a degree that abdominal muscle work outs and results can be accelerated. Moreover, it would be desirable to have a device that constricts the outgrowth of abdominal muscles and keep the abdomen looking slim. Thus, what is needed is a solution and method for helping the exerciser stabilize and properly position and isolate her core to create highly effective, repetitive core exercises, with the option of promoting tighter skin on the abdomen for those who want that.

### SUMMARY OF THE INVENTION

The present invention meets these needs and more by employing a novel system, device and method for stabilizing the abdominal region of a user while the user exercises his or her core. The device includes an elongated wrap having an outer side, an inner side, a first end and a second end, and the wrap is for securely wrapping around the abdomen of the user. The device also includes a weight-receiving pocket attached to the outer side of the wrap near its first end and is adapted for positioning over the abdominal region of the user when the wrap is wrapped. With a weight placed in the pocket, the device effectively stabilizes the core by promoting an improved, flat, unarched back position.

The device further includes a securing mechanism, such as a “hook and loop”, or Velcro™, system on the inner side and near the second end of the wrap. This enables the wrap or belt to be removably secured to a portion of the outer side of the belt when wrapped around the abdomen.

In other embodiments, the device also includes an acupressure array disposed on the inner side and opposing the pocket for applying pressure on the abdomen. The acupressure array preferably includes a plurality of acupressure discs that are positioned to contact, directly or indirectly, the skin of the abdomen when the wrap is secured about the abdomen.

Preferably the acupressure array is disposed on a sheet that is removably connected to the inner side, such as with Velcro.

In some embodiments, the elongated wrap is stretchable and made of neoprene. In complementary embodiments, the inner side of the elongated wrap is lined with nano-silver material.

In other implementations of the present invention, the device is a system that includes one or more weights disposed in the weight-receiving pocket. The weights may be permanently installed in the picket or may be removed from via an opening in the pocket.

In embodiments, a device for stimulating a plurality of layers of skin on the abdomen of an exerciser is disclosed. This device preferably includes an elongated wrap having an outer side, an inner side, a first end and a second end, the wrap for securely wrapping around the abdomen of the user; and an acupressure array on the inner side and near the first end of the wrap, such that when the device is worn, the array is in forceable contact with the abdomen of the exerciser. This array may be disposed on a sheet and may comprise a plurality of acupressure discs each having one or more spikes that contact the abdomen when worn.

Moreover, a novel method for an exerciser to exercise the core of the body using an elongated belt is disclosed herein. The method includes securely wrapping the belt around the abdomen of the exerciser. Then, the exerciser lays flat on the ground so that the back is substantially flush with the ground. Then he may conduct core exercises. This method preferably further includes inserting a weight in a weight-receiving pocket on the belt, either before or after wrapping the belt around the abdomen. Alternatively, the belt may already include a weight for positioning opposite the abdomen when the belt is securely wrapped.

The method of the present invention disclosed herein also includes the option for conducting these back stabilized exercises, while simultaneously stimulating blood flow to layers of the skin of the abdomen with an acupressure array disposed on an inner side of the belt and in contact with the abdomen. Preferably, the acupressure array is located on the belt opposite the weight-receiving pocket.

It is to be understood that the inventions are not limited in their application to the details of construction and the arrangement of components described hereinafter and illustrated in the drawings. Those skilled in the art will recognize that various modifications can be made without departing from the scope of the disclosure.

### BRIEF DESCRIPTION OF THE FIGURES

FIG. 1A is a top view one embodiment of the present Core Set™ belt system invention as would be wrapped around the abdomen of a user;

FIG. 1B is a front view of the Core Set™ invention shown in FIG. 1A;

FIG. 1C is a back view of the Core Set™ invention shown in FIGS. 1A and 1B;

FIG. 2 is an exemplary side cross-sectional cutaway view of one embodiment of the Core Set™ invention of the present invention;

FIG. 3 is a perspective view of the weight pocket of the present invention showing a weight disc being inserted therein;

FIG. 4 is an exemplary acupressure array disposed on a sheet that may be attached to the Core Set™ belt shown in FIGS. 1A-1C according to another embodiment of the present invention;

FIG. 5 is a magnified view of one exemplary acupressure disc in the array shown in FIG. 4;

FIG. 6 is a diagram showing a partial view of an exerciser wearing the Core Set™ belt system of the present invention in one embodiment;

FIG. 7 is a diagram showing a partial view of an exerciser wearing an embodiment of the Core Set™ belt system of the present invention along with an optional tightening belt according to another embodiment of the present invention; and

FIG. 8 is a diagrammatic top view of an embodiment of the Core Set™ belt system of the present invention as would be worn around an abdomen together with the optional tightening belt layered over the belt system.

### DETAILED DESCRIPTION OF THE INVENTION

The inventor of the present invention has developed a novel waist wrap, or abdominal belt, and core work-out system, which the inventor calls the Core Set™ system. When worn by an exerciser, the system promotes maximize abdominal isolation of each rep in an “on-the-back” core exercise set by helping force or promote the back to stay flush with the ground, thereby stabilizing the core. Optionally, the system also simultaneously stimulates blood flow to the abdominal skin surface for additional benefits, all in a simple, low cost and portable solution.

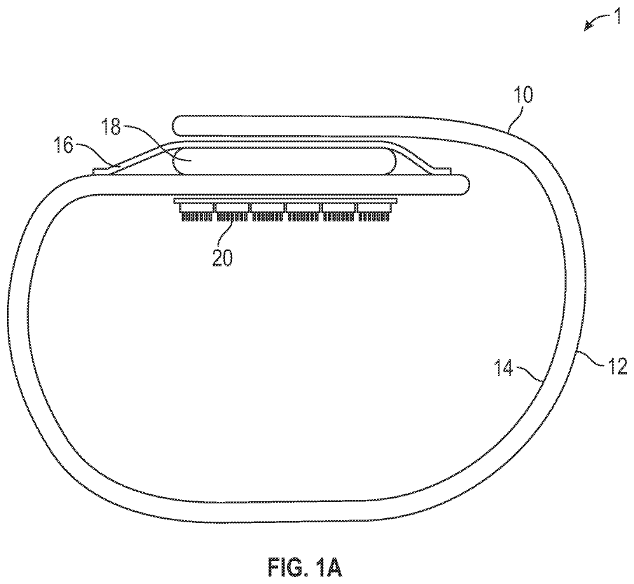

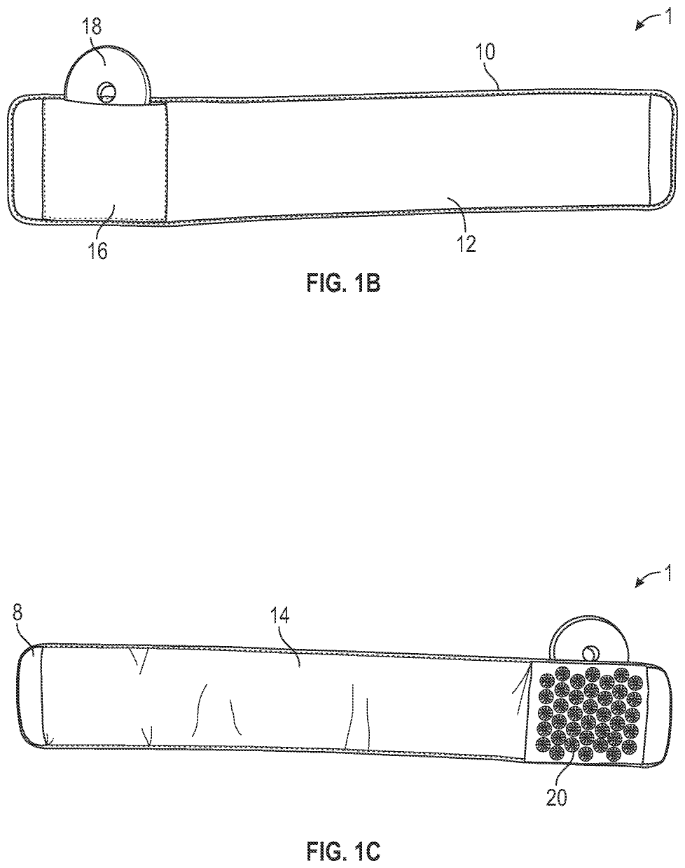

Referring now to the figures, FIGS. 1A, 1B and 1C show various diagrammatic views of one preferred embodiment of the present invention called the Core Set™ system 1. The system comprises an elongated, preferably rectangular-shaped, wrap or belt 10 and a weight 18, seen here as a plate or disc, that is about to be inserted into wrap 10. In particular, FIG. 1A is a top view of this embodiment of system 1, shown in a closed, as-worn position, as would be positioned around an abdomen of an exerciser. FIG. 1B is a front view of belt system 1 showing the front or outer (exposed to the outside) side 12 of wrap 10 in an open position, with disc-shaped weight 18 partially inserted in weight-receiving pocket 16, which is preferably integral with wrap 10. FIG. 1C is a back view of wrap system 1 with belt 10 in a fully open position showing its inner surface or inner side 14, which is the side that faces the abdomen or clothing of the user when wrapped.

In this exemplary embodiment, weight 18 is a single disc-shaped weight and may any weight or shape that is appropriate for device 10. The inventor has found that a 5-lb, or 10-lb. weight (or two 5-lb. weights) works well. In other embodiments, weight 18 may be made a permanent part of inventive belt 10.

Preferably, belt 10 is made of neoprene material having inner surface 14 coated or lined with a “nanosilver” or “nano-silver” lining material. A nanosilver coating makes belt 10 more durable over time than neoprene alone which can more easily rip over time. Nanosilver coating is also easy to clean. Moreover, a nanosilver lining can help to prevent the growth of microorganisms, reducing odors and improving hygiene. Finally, a nanosilver lining does not pinch or irritate the skin as much as neoprene against the skin does. However, no lining or other lining material may be employed within the scope of the present invention.

As further seen in FIG. 1C, belt 10 preferably also includes acupressure sheet 20 attached to one end of inner side 14. In preferred embodiments, acupressure sheet 20 is attached toward one end of inner side 14 using a “hook and loop” or Velcro® system. That way, a user can easily remove and reattach sheet 20 as desired. As best seen in FIGS. 1A and 1C, weight pocket 16 on outer side 12 is preferably directly opposing acupressure sheet 20 on inner side 14.

In the preferred embodiment, outer side 12 is largely covered with one of a hook and loop material, which can removably attach, or cling, to mating hook and loop material disposed on inner side 14. Thus, as seen in FIG. 1C, provided is a Velcro® strip 8 preferably sewn or otherwise permanently connected to the opposite end of inner side 14 opposing the end that mates with acupressure sheet 20.

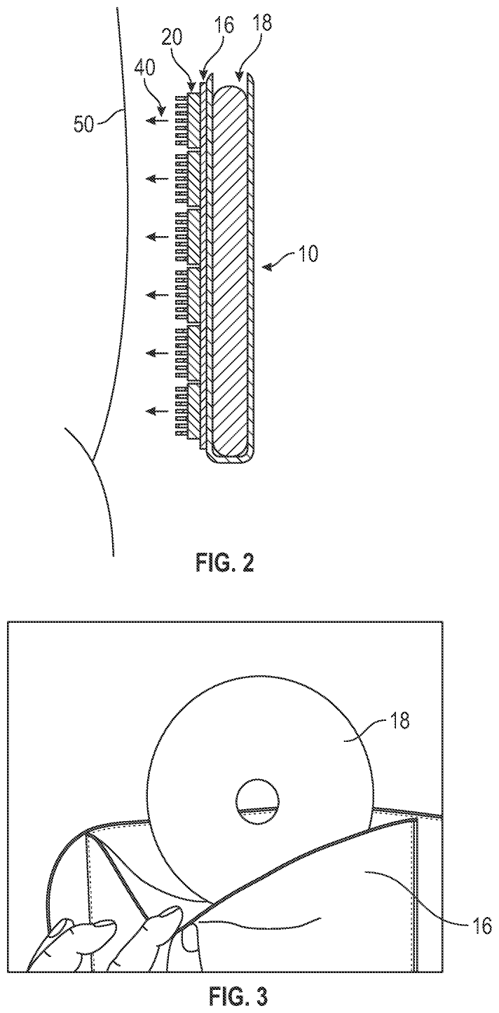

As seen in FIG. 6, preferred belt system 1 of the present invention is intended to be worn by user 100, and when properly worn during exercises, such as during sit-ups or crunches, system 1 simultaneously isolates the workout to the central abdominal region 50 of user 100 and promotes blood flow to that same region. Thus, as seen here, the Core Set™ abdominal belt 10 is made wide enough to cover a substantial portion of the exerciser's abdomen. Accordingly, FIG. 2 shows an exemplary side cutaway cross-sectional view of belt system 1 of the present invention when in position to be pressed against abdomen 50 of user 100, according to an embodiment that tracks FIGS. 1A-1C. As seen, when wrapped around abdomen 50, acupressure sheet 20 is in position to move in the direction of arrows 40 into and push against abdomen 50. And with weight 18 inside pouch 16 of belt 10 pressing down on abdomen 50 when user 100 is laying down, a spiked weighted pressure is applied to a large surface area of the abdomen; spiked, to supply massage the front torso skin with acupressure sheet 20; and weighted pressure, from weight 18 to provide stability by retarding back arching and promoting proper sit-up, crunch, etc. posture.

Turning now to FIG. 3, shown is a close-up view of weight pocket 16 disposed on the front side 12 of belt 10 with weight 18 partially inserted therein, with a person's hand assisting with the insertion. As seen in this embodiment, weight 18 is preferably disc-shaped having a circumference that snugly inserts into pocket 16's opening, which is preferably made of stretchable material such as neoprene. In one preferred embodiment, weight 18 is a 5-lb. weight. However, it should be understood that the specific weight and shape of weight 18 is not essential to the present invention and may be other shapes, sizes and weights. Moreover, pocket or pouch 16 may be configured hold more than one weight 18. Thus, for example, user 100 may insert two 5 lb. discs. For the first weeks of training with the system of the present invention, user 100 may decide to use one 5 lb. disc 18. However, as the core (rapidly) strengthens, at some point user 100 may insert a second 5 lb disc 18a in order to isolate the core abdominal muscles even more for a more dramatic improvement/results. Thus, pocket 18 is preferably sized so that it can securely hold one, two or more weight discs. Moreover, optionally (not shown) the opening at the top of pocket 16 may be closed after insertion of the weight/s using any appropriate closing means, so that the weight/s does not inadvertently slide out pocket 16 when either putting or taking off belt 10 or carrying it. This closure can be any appropriate structure whether a strip of hook and loop material on the inner side at the open end of pocket 16 that sealingly mates with mating hook and loop material on belt 10.

As discussed briefly above, an optional feature of the present invention is for belt system 1 to also supply acupressure treatment to the abdomen while using it for core exercises. Acupressure is a therapy modality that involves applying pressure to specific points on the body to alleviate pain, reduce stress, promote blood flow to the area and to promote relaxation. This technique is based on traditional Chinese medicine principles and the belief that the body has energy pathways, known as meridians, that can be accessed through specific points. Acupressure points are typically located along these meridians and correspond to specific organs or functions within the body. The pressure applied to these points can stimulate the body's natural healing processes, release tension, and promote a sense of well-being.

Conventionally, acupressure may be performed during massages using fingers, hands and elbows. However, performing acupressure on a person's skin using “spiked” components (that is, structures that terminate in spikes that “dig” into the skin) is known to stimulate blood flow to the treated skin area. It is believed that this action on the surface of skin can help tighten the skin, even loose skin, by promoting the fascia tissue—connective tissue that surrounds muscles, bones, and organs in the body—to connect to the muscle below the skin.

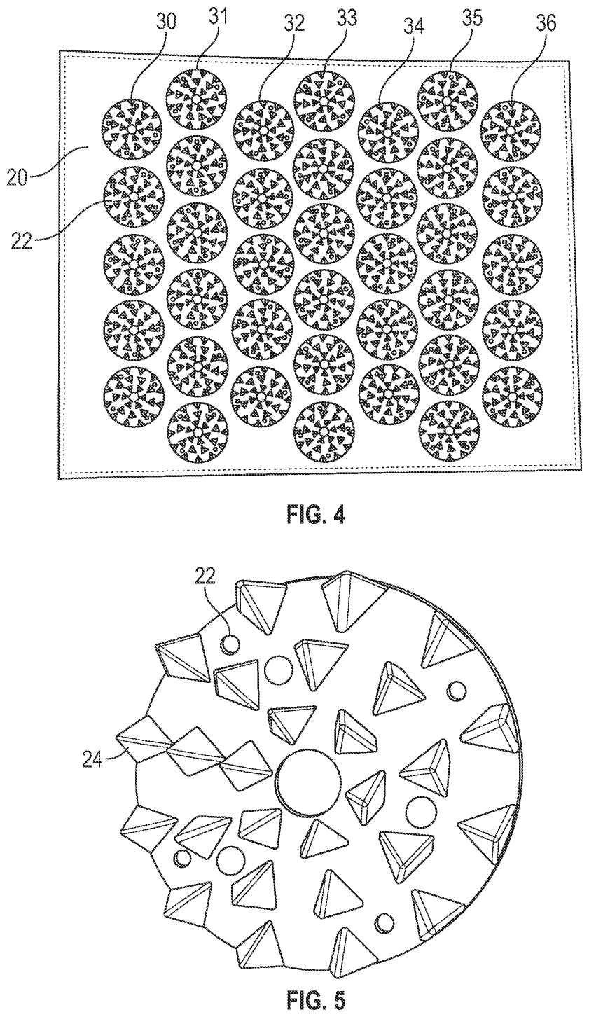

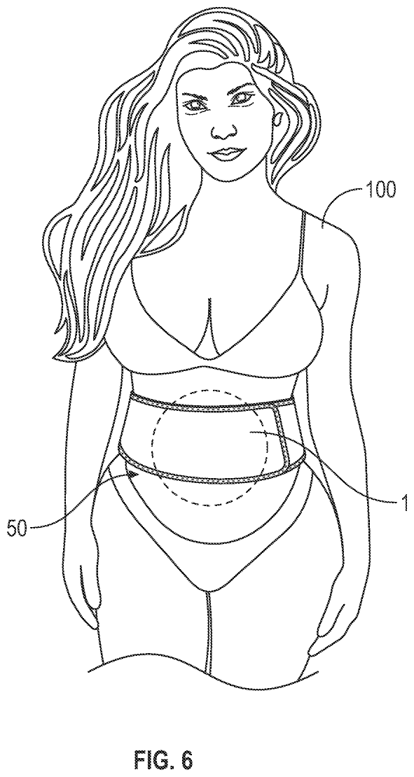

Accordingly, FIGS. 4 and 5 show details of one such optional, preferred solution incorporated into belt 10 of the present invention. FIG. 4 shows a substantially rectangular or square acupressure sheet 20 having an array of multiple circular spiked discs 22, preferably arranged in a pattern on the front side of sheet 20. Referring back to FIG. 1C, the back side of sheet 20 (not shown) is preferably attached toward one end of inner side 14 of belt 10. Preferably, sheet 20 is removably attached via a hook and loop system, such as Velcro® (not shown). This enables user 100 to remove and reattach acupressure sheet 20 at will.

Looking more closely at circular spiked discs 22, FIG. 5 shows an enlarged view of one such preferred disc. As seen, the front side of disc 22 includes sharp pyramid-like spikes 24 arranged in three concentric circles. Each spike 24 terminate in a relatively sharp point. Thus, in preferred embodiments, more than 20 spikes 24 are disposed on each disc 22, providing substantial acupressure pressure coverage on an exerciser's abdominal skin area that each spoke 24 presses against across the entire surface of each disc 22.

Turning back to FIG. 4, each spike 22 is preferably permanently attached to sheet 20. However, it should be understood that these spikes 22 may be removable should a user want to adjust the positioning or number of spikes to press against the abdomen. In this preferred embodiment, however, acupressure sheet 20 comprises an array of 7 rows 30-36 (or columns, in the orientation shown in FIG. 4) of strategically placed discs 22. The idea here is to provide excellent coverage of the abdominal core of the user.

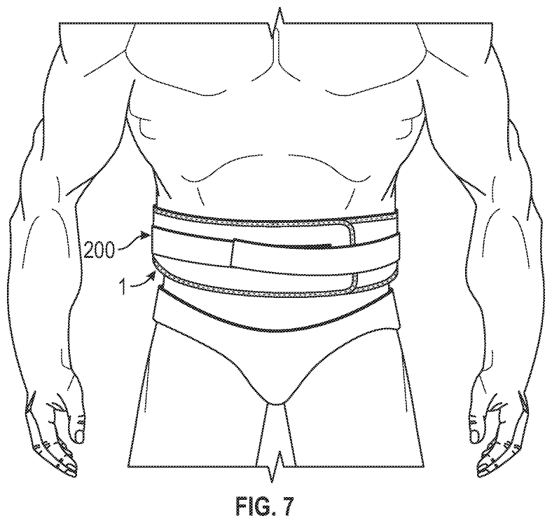

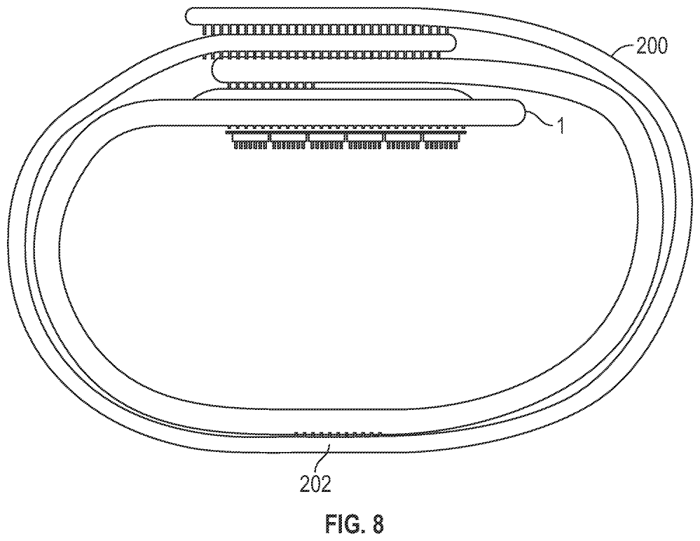

For some exercisers, having belt 10 be very snug or even tightly wrapped about the torso is desirable to “teach” the abdominal muscles that they only have certain amount of room to grow outwardly so they won't get unappealingly (for some) extended abdomen muscles. For others, having an extra measure of snugness just feels right. Because belt 10 is some embodiments may be infinitely adjustable at the waist because of the Velcro design across most of outer side 12, belt 10 can be wrapped about the abdomen very tightly. However, for some that won't be enough. Also, because torso moves and contorts so much during certain core exercises, the body expansions and contractions can slightly stretch out belt 10 or slightly loosen the Velcro connections. Accordingly, turning now to FIGS. 7 and 8, shown is an additional embodiment of the invention in which belt system 1 is supplemented with an additional component, namely tightening strap 200.

Tightening strap 200 is designed to enhance the athletic multi-modality exercise experience. It allows the user to set a desired amount of additional compression pressure around the circumference of the Core Set™. Strap 200 wraps around belt 10 and preferably its inner side is secured to the outer side 12 of belt 10 at at least two points, specifically hook and loop connections at locations 202 and 204.

Strap 200 also allows the user to loosen or tighten the pressure during specific exercise modalities without removing the entire Core Set simply by peeling each end of the strap away and re-applying it in fashion. This offers flexibility for cross-training, aerobic, and other longer duration exercises as well as quicker burst exercises as needed.

It should also be understood that belt 1 in any of the embodiments disclosed here or otherwise within the scope of the invention is not limited to use during “back to the ground” core exercises. It may be worn and provide benefits while the user in is other positions such as the stand-up position, whether worn while walking, jogging, or any other activities and exercises.

Although the invention has been described in connection with certain embodiments, it is not limited to them. Modifications within the scope of the following claims will be apparent to those skilled in the art without derogating the scope of the applicants' novel contribution to the art.

1. A wrap device for stabilizing the abdominal region of a user while the user exercises his or her core, comprising:
a. an elongated wrap having an outer side, an inner side, a first end and a second end, the wrap for securely wrapping around the abdomen of the user; and
b. a weight-receiving pocket attached to the outer side of the wrap near its first end and adapted for positioning over the abdominal region of the user when the wrap is wrapped.

2. The device of claim 1, further including a securing mechanism on the inner side and near the second end of the wrap, for removably securing the second end to a portion of the outer side when wrapped around the abdomen.

3. The device of claim 2, wherein the securing mechanism is a strip of material comprising one of a plurality of hooks or a plurality of loops disposed on its surface.

4. The device of claim 1, further including an acupressure array disposed on the inner side and opposing the pocket for applying pressure on the abdomen.

5. The device of claim 4, wherein the acupressure array comprises a plurality of acupressure discs that are positioned to contact, directly or indirectly, the skin of the abdomen when the wrap is secured about the abdomen.

6. The device of claim 4, wherein the acupressure array is disposed on a sheet that is removably connected to the inner side.

7. The device of claim 1, wherein the elongated wrap is stretchable.

8. The device of claim 1, wherein the inner side of the elongated wrap is lined with nano-silver material.

9. The device of claim 1, further including a weight disposed in the weight-receiving pocket.

10. A device for stimulating a plurality of layers of skin on the abdomen of an exerciser, comprising:
a. an elongated wrap having an outer side, an inner side, a first end and a second end, the wrap for securely wrapping around the abdomen of the user; and
b. an acupressure array on the inner side and near the first end of the wrap, such that when the device is worn, the array is in forceable contact with the abdomen of the exerciser.

11. The device of claim 10, wherein the array comprises a plurality of acupressure discs each having one or more spikes that contact the abdomen when worn.

12. The device of claim 10, further wherein the array is disposed on a sheet that is removably attached to the inner side of the wrap.

13. A method for an exerciser to exercise the core of the body using an elongated belt, the method comprising:
a. securely wrapping the belt around the abdomen of the exerciser;
b. the exerciser laying flat on the ground so that the back is substantially flush with the ground; and
c. conducting core exercises.

14. The method of claim 13, further including inserting a weight in a weight-receiving pocket on the belt, after wrapping the belt around the abdomen.

15. The method of claim 13, wherein the belt includes a weight for positioning opposite the abdomen when the belt is securely wrapped.

16. The method of claim 13, further including, while conducting the exercises, stimulating blood flow to layers of the skin of the abdomen with an acupressure array disposed on an inner side of the belt and in contact with the abdomen.

17. The method of claim 14, wherein the acupressure array is located on the belt opposite the weight-receiving pocket.
